(19) United States
(12) Patent Application Publication
(10) Pub. No.: US 2022/0043324 A1
(43) Pub. Date: Feb. 10, 2022

(54) LENS CAPS WITH DUAL HINGES

(71) Applicant: Hewlett-Packard Development Company, L.P., Spring, TX (US)

(72) Inventors: Jonathan Michael Anderson, Fort Collins, CO (US); Matthew Flach, Fort Collins, CO (US)

(73) Assignee: Hewlett-Packard Development Company, L.P., Spring, TX (US)

(21) Appl. No.: 17/414,201

(22) PCT Filed: Apr. 29, 2019
(86) PCT No.: PCT/US2019/029696

§ 371 Date: Jun. 15, 2021

(51) Int. Cl. G03B 11/04; G02B 27/01

(52) U.S. Cl. CPC G03B 11/04; G02B 2027/0154; G02B 27/0176

(57) ABSTRACT

In an example, a lens cap may include a cover sized to overlay and/or conceal or cover an eye lens of a head-mounted display. The lens cap may further include a dual hinge to move the cover between an open position and a closed position. The dual hinge may include a first hinge attached to or disposed on the cover, and a second hinge to attach to a chassis of the head-mounted display.

### BACKGROUND

Electronic devices such as computing devices may provide an immersive audio-visual experience for a user. Such devices may include virtual-reality (VR) and augmented-reality (AR) computing devices or systems. Such devices may include a head-mounted display (HMD) which may provide a visual display of content for the user. Such HMD's may provide realistic and immersive visual data and/or content, which may encourage the user to feel like he or she is experiencing the visual scenario first-hand or in real life. Additionally, VR and/or AR systems may also provide audio signals and/or content to the user, from headphones or speakers, that is in-sync with the visual content and may also be directional in nature, thereby increasing the immersive experience for the user.

### BRIEF DESCRIPTION OF THE DRAWINGS

FIG. 1A is a perspective view of an example lens cap having a dual hinge.

FIG. 1B is a perspective view of the example lens cap of FIG. 1A.

FIG. 1C is a top view of the example lens cap of FIG. 1A.

FIG. 1D is a top view of the example lens cap of FIG. 1A.

FIG. 1E is a top view of the example lens cap of FIG. 1A.

FIG. 2A is a perspective view of a VR system having an HMD with an example lens cap with a dual hinge.

FIG. 2B is a detail perspective view of the HMD and example lens cap of the VR system of FIG. 2A.

FIG. 2C is a detail perspective view of the HMD and example lens cap of the VR system of FIG. 2A.

FIG. 2D is a front view of the HMD and two example lens caps of the VR system of FIG. 2A.

FIG. 3A is a perspective view of an HMD having an example lens cap.

FIG. 3B is a perspective view of an HMD having an example lens cap.

### DETAILED DESCRIPTION

Electronic devices such as VR and AR computing devices or systems may provide an immersive simulated audio-visual experience for a user, providing the user the sense that they are immersed within, and experiencing first-hand, the content of which they are seeing and hearing. In order to provide such an immersive experience, VR and AR systems or devices may include eye lenses disposed in front of a display or displays. It may be desirable to keep the eye lenses of such a system or device clean, clear, and/or free of scratches, smudges, oils, or other defects or contaminants, so as to prevent such defects or debris from negatively affecting the visual simulation or content that the user is experiencing.

In some situations, a cleaning cloth or fabric may be used to clean and clear the eye lenses of an AR and/or VR system if smudges, oil, or debris is present, however such items do not prevent future damage or defects from occurring. In other situations, stretchable lens covers or HMD covers may be employed to protect the eye lenses when the system or device is not in use. However, such covers are a standalone item and may be prone to loss, becoming dirty themselves, and/or are inconvenient to use. In further situations, individual clear lens covers may be placed on each of the eye lenses in order to protect against scratches and debris, however such a solution can still catch and retain dirt, oil, or other contaminants either on the cover or in between the cover and the lens, which can negatively affect, distort, or block the visual content seen through the eye lenses.

In some situations, it may be desirable to employ an integrated protective solution into a VR or AR system, or an HMD thereof, in order to provide protection for eye lenses from dirt, oil, scratches, or other contaminants so as to preserve the quality of the visual simulation and content provided by the system or device. It may be desirable that such a protective solution be integrated into and be a part of the HMD such that it is easy and convenient to employ, and also to prevent loss or damage to the protective device. Additionally, when not in use protecting eye lenses, it may be desirable that the protective solution does not interfere with the fit and/or function of the HMD or the AR or VR system as a whole.

Implementations disclosed herein provide lens caps with hinges that may be attached to or integrated with an HMD of an AR or VR system in order to protect eye lenses thereof from damage, dirt, oils, or other contaminants or defects when the system or device is not in use. Further, such lens caps with hinges may be conveniently folded out of the way of the user when the AR or VR system is being operated so as to avoid negatively affecting the fit or function of the system, or discomfort to the user.

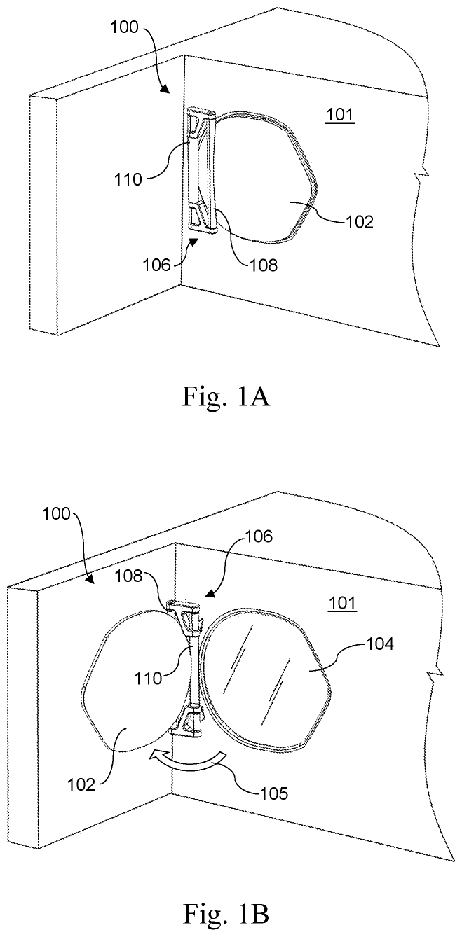

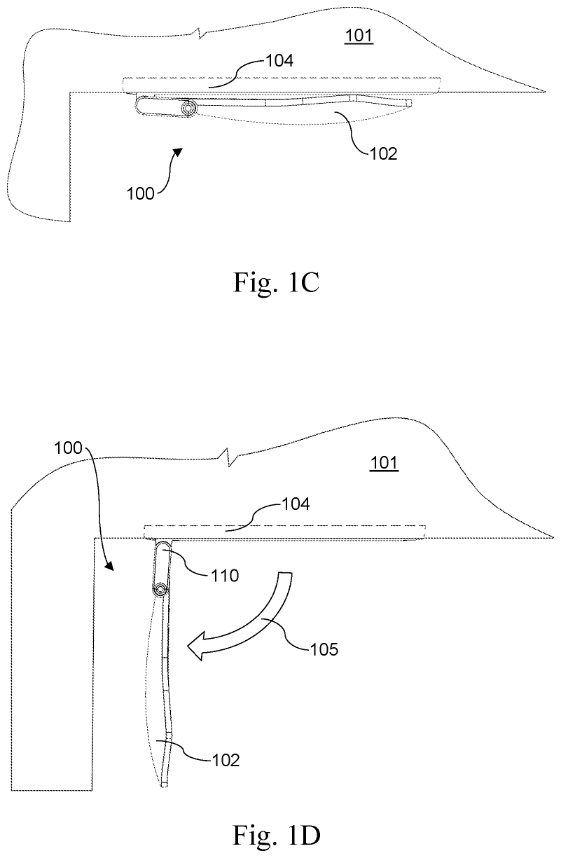

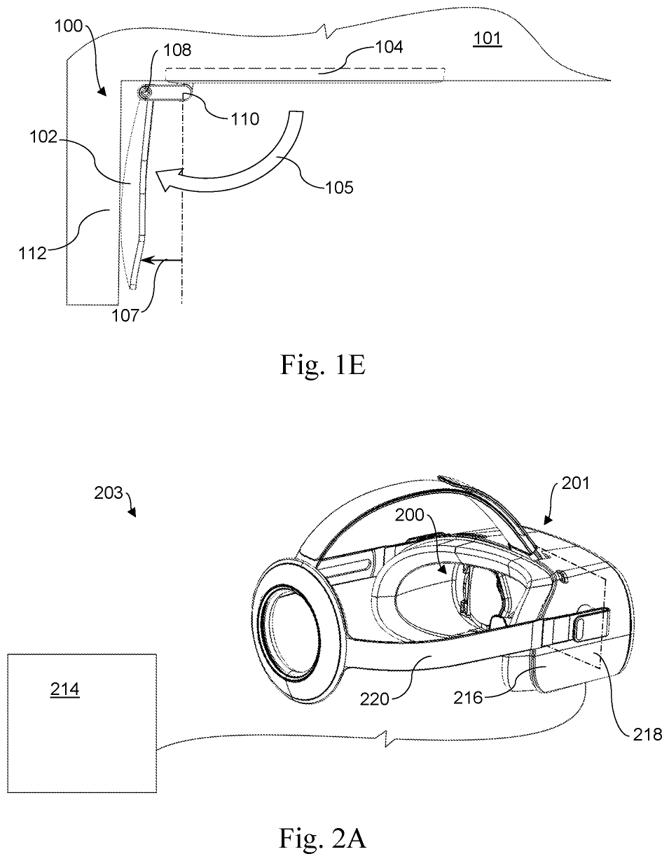

Referring now to FIG. 1A, a perspective view of an example lens cap 100 having a dual hinge 106 is illustrated. Lens cap 100 may include a cover 102 sized to overlay and/or conceal or cover an eye lens 104 of an HMD 101. Lens cap 100 may further include a dual hinge 106 to move the cover 102 between an open position (FIG. 1B) and a closed position (FIG. 1A). In some implementations, the dual hinge 106 may be disposed near an outer edge of the cover 102. The dual hinge 106 may include a first hinge 108 attached to or disposed on the cover 102, and a second hinge 110 to attach to a chassis of the HMD 101. Referring now to FIG. 1B, another perspective view of example lens cap 100 is illustrated wherein the cover 102 is disposed in the open position. The lens cap 102 has moved, for example, along direction 105 to transition from the closed position, covering the eye lens 104, to the open position, revealing the eye lens 104 and allowing visual content to be viewed through the eye lens 104.

The cover 102 may be a rigid or semi-rigid panel or member, such that it may withstand environmental conditions like dirt, dust, debris, or other contaminants, and prevent such contaminants from becoming disposed on the eye lens 104 when the cover 102 is in the closed position. Further, the cover 102 may be about the same size as the eye lens 104, or larger than the eye lens 104. In some situations, the cover 102 may have a similar or matching profile and/or shape as the eye lens 104 to more closely fit against and protect the eye lens 104. In further implementations, the cover 102 may include a ridge, gasket, or similar type of component on an inside surface or edge of the cover 102 to more closely seal against and/or around the periphery of the eye lens 104.

The dual hinge 106 may include a first hinge 108 and a second hinge 110. In some implementations, the first hinge 108 may be attached to or be a unitary part of the cover 102. In other implementations, the first hinge 108, or a part thereof, may be co-molded with or onto the cover 102 such that they form a unitary component. In other implementations, the first hinge 108 may be attached to or coupled to the cover 102 through intermediary components. In some examples, the first hinge may be a single post or bar that extends substantially vertically along a height of the cover 102, and protrudes from both a top portion and a bottom portion of the cover 102 so as to engage with other bars, linkages, brackets or other components of the dual hinge 106. Similarly, the second hinge 110 may be attached to or coupled to the HMD or a chassis or other component thereof either directly, indirectly, through intermediate components, or may be a unitary part of such a component of the HMD, e.g., co-molded with the component or part of the HMD. In further examples, the second hinge 110 may have a similar structure, e.g., a bar or post type structure, to that of the first hinge 108. The second hinge 110 may extend vertically along the portion of the HMD to which it is attached, alongside the first hinge 108, such that distal ends of the first hinge 108 and the second hinge 110 may be engaged with one another through brackets, linkages, bars, or other components of the dual hinge 106. In some examples, the dual hinge 106 may be structured such that the top portions of the first and second hinges 108 and 110 rotate at the same time or rate as the bottom portions of the first and second hinges 108 and 110, respectively. This ensures smooth operation of the dual hinge 106 in transitioning the cover 102 between the closed and open positions.

Referring now to FIG. 1C, a top view of the example lens cap 100 is illustrated in which the cover 102 is disposed in the closed position, protecting and concealing the eye lens 104, shown in phantom as being disposed within the HMD 101. Referring additionally to FIG. 1D, another top view of the lens cap 100 is illustrated in which the cover 102 has been partially rotated, pivoted, or otherwise transitioned from the closed position illustrated in FIGS. 1A and 1C toward the open position. Specifically, the cover 102 and the dual hinge 106 have rotated along example direction 105 about the pivot point of the second hinge 110. Note, in this position, while the eye lens 104 is now revealed and unprotected, the cover 102 is still disposed closely to the edge of the eye lens 104. In this position, the cover 102 may interfere with a user's face, eyeglasses, cheek, etc., and may make wearing the HMD uncomfortable, impractical, or may otherwise diminish the experience of using the HMD. As such, the first hinge 108 may also rotate about its pivot point to further space the cover 102 away from the eye lens 104, as illustrated in FIG. 1E. FIG. 1E illustrates another top view of the example lens cap 100 in which the cover 102 has fully transitioned to the open position along direction 105. Specifically, compared to FIG. 1D, the dual hinge 106 and the cover 102 have further rotated about the pivot point of second hinge 110, and also rotated about the pivot point of the first hinge 108. Such a compound movement effectively both rotates the cover 102 away from the eye lens 104 in order to uncover and reveal the eye lens 104 and also translates the cover 102 laterally from the eye lens 104, e.g., along direction 107, compared to the position of the cover 102 in FIG. 1D. This is illustrated as the dotted line from which arrow 107 extends. In some examples, the cover 102 may be translated along direction 107 the same distance as the spacing between the first hinge 108 and the second hinge 110. Thus, the size and spacing between the hinges of the dual hinge 106 may be selected or designed based on how far it is desired to have the cover 102 spaced from the eye lens 104 when in the open position. The cover 102, as such, may be spaced away from the eye lens 104 sufficiently to allow room for a user's face, eyeglasses, cheek, etc. The cover 102, in some examples, may be disposed adjacent to, next to, or pressed against a lateral component 112 of the HMD, for example, a face gasket in some implementations. It should be noted that while such a compound movement of the cover 102 is illustrated in two different motions, i.e., the rotation about second hinge 110 in FIG. 1D and the rotation and translation in FIG. 1E, such a movement could be effected more efficiently in a single fluid motion in which both first and second hinges 108 and 110 operate simultaneously to sufficiently space the cover 102 both rotationally and laterally away from the eye lens 104.

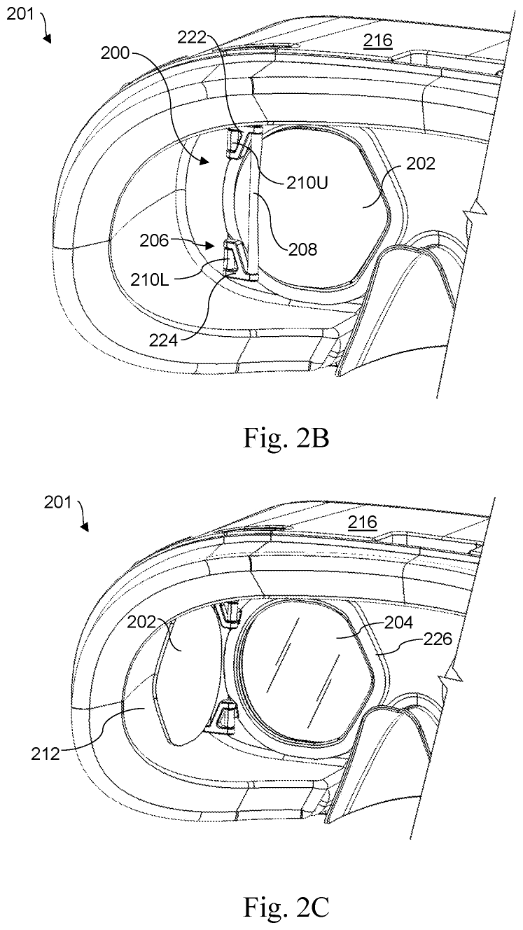

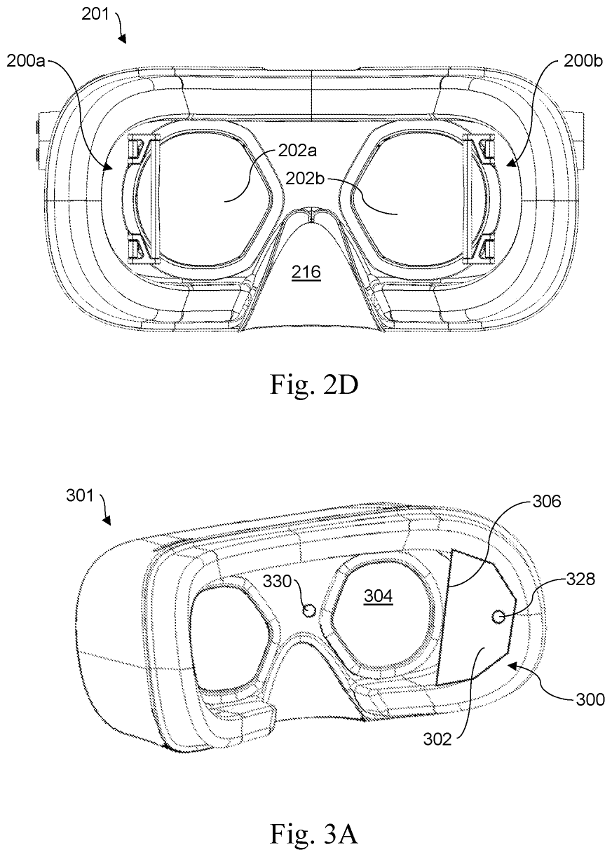

Referring now to FIG. 2A, a perspective view of a VR system 203 having an HMD 201 with an example lens cap 200 is illustrated. Example lens cap 200 may be similar to example lens cap 100, described above. Further, the similarly-named elements of example lens cap 200 may be similar in function and/or structure to the respective elements of example lens cap 100, as they are described above. In some examples, the VR system may include a computing device 214 to provide visual immersive content. The computing device 201 is illustrated schematically as a box 214, and may have a variety of form factors or structures. For example, in some implementations, the computing device 214 may be a desktop personal computer (PC), a notebook PC, a tablet, a smartphone, a harness-mounted computing system such as a VR backpack, or another type of computing device capable of providing immersive visual content to the HMD.

The VR system 203 may also include an HMD 201 operably connected to the computing device 214 to be worn or otherwise utilized by a user to experience the VR simulation provided by the computing device 214. In some examples, the HMD 201 may include a head-strap or harness 220, a chassis 216, and a display or displays 218 disposed within the chassis 216. Display 218 is illustrated in phantom within the chassis 216. The display 218 may be used to show visual simulated and/or immersive content from the computing device, which may be viewed by a user through an eye lens or pair of eye lenses. It should be noted that the HMD, chassis 216, and harness 220, etc., may have a structure or industrial design other than as depicted. In some examples, the computing device 214 may be a part of or integrated into the HMD itself, or may be operably connected to the HMD through a wireless connection technology.

Referring now to FIG. 2B, a detail perspective view of the HMD 201 and example lens cap 200 of the VR system 203 is illustrated. The lens cap 200 may include a cover 202 to removably cover or conceal the eye lens of the HMD 201. FIG. 2B illustrates the cover 202 of the lens cap 200 as being disposed in a closed position over an eye lens 204 of the HMD 201 in order to protect the eye lens 204 from dirt, debris, scratches, smudges, etc. which may originate from the environment. Referring additionally to FIG. 2C, another detail perspective view of the HMD 201 and example lens cap 200 is illustrated wherein the cover 202 is disposed in an open position, clear of and revealing the eye lens 204. The eye lens 204 may be disposed on or in the chassis 216 in front of the display 218 (not shown in FIGS. 2B-2D) such that the display 216 may be viewed by a user through the eye lens 204. Further, the HMD may include a face gasket 212 extending, at least partially, around an outer edge of the chassis 216. The face gasket 212 may touch or contact the face of a user when a user is wearing the HMD.

The lens cap 200 may further include a dual hinge 206 to pivotably attach the lens cap 200, or the cover 202 thereof, to the chassis 216 adjacent to the eye lens 204. The dual hinge 206 may pivot or move the cover 202 between the open position and the closed position. Further, the dual hinge 206 may both rotate and translate the cover 202 away from the eye lens 204 so as to sufficiently space the cover 202 away from the eye lens 204 when in the open position. In some implementations, when disposed in the open position, the cover 202 may be disposed adjacent to or pressed against the face gasket 212 in order to be sufficiently spaced from the eye lens 204. The dual hinge 206 may include a first hinge 208 attached to the cover 202, and a second hinge to attach to the chassis 216 of the HMD. In some implementations, the second hinge may include an upper hinge portion 210U and a lower hinge portion 210L. The upper hinge portion 210U and the lower hinge portion 210L may engage with the first hinge 208 through an upper hinge bracket 222 and a lower hinge bracket 224, respectively. The upper hinge bracket 222 and the lower hinge bracket 224 may enable the cover 202 and the first hinge 208 to rotate about a pivot point of the second hinge to, along with rotation of the cover 202 about the pivot point of the first hinge 208, transition, pivot, or otherwise move the cover 202 between the open position and the closed position.

In some implementations, the HMD 201 or the chassis 216 thereof, may include a lens trim 226 peripherally surrounding, at least partially, the eye lens 204. In such an example, the second hinge, or the upper hinge portion 210U and lower hinge portion 210L thereof, may be attached to the lens trim 226 in order to dispose the lens cap 200, and thus the cover 202, adjacent to the eye lens 204. In such implementations, the cover 202 may rotate, translate, or otherwise move as described above relative to the lens trim 226 when moved between the open and closed positions.

Referring now to FIG. 2D, a front view of the HMD 201 is illustrated. In some implementations, the HMD may have a pair of eye lenses, i.e., a first eye lens and a second eye lens. As such, in such examples, the lens cap 200 may be a first lens cap 200a and the HMD 201 may further include a second lens cap 200b, which may be similar in structure and/or function to the first lens cap 200a. First lens cap 200a may have a first cover 202a to removably protect and conceal a first eye lens, and second lens cap 200b may have a second cover 202b to removably protect and conceal a second eye lens. Both the first cover 202a and the second cover 202b may operate and move between closed positions (illustrated) and open positions, as described above. In other implementations, the first cover 202a and the second cover 202b may each have dual hinges. In some examples, the dual hinges may be disposed laterally outwards from the eye lenses, as illustrated, and thus the first cover 202a and the second cover 202b may both pivot and translate outwards to move to the respective open positions. In other implementations, the dual hinges may be placed anywhere along the periphery of the covers, e.g., on a top edge, bottom edge, inner edge, etc. In such implementations, the first cover 202a and the second cover 202b may pivot and translate in directions corresponding to the specific location of the respective dual hinge in order to move between the open and closed positions.

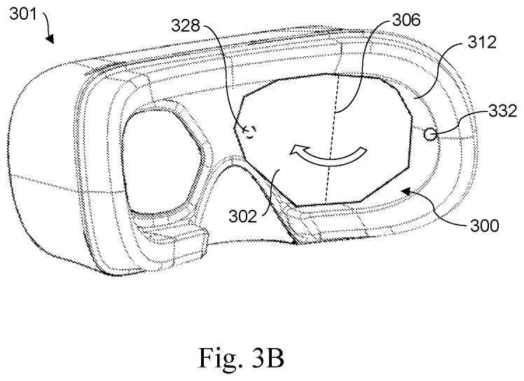

Referring now to FIGS. 3A and 3B, perspective views of an HMD 301 having an example lens cap 300 are illustrated. Lens cap 300 may include a cover 302 and a hinging portion 306. Lens cap 300 may be moved between an open position (FIG. 3A) in which an eye lens 304 of the HMD 301 is exposed, and a closed position (FIG. 3B) in which the cover 302 is concealing, covering, or otherwise protecting the eye lens 304 by the hinging portion 306. In some implementations, the hinging portion 306 may be a dual hinge, as described above, and may be disposed near an outer edge of the cover 302. In other implementations, the hinging portion 306 may be a central hinge, as illustrated in FIGS. 3A-3B, and may be disposed in or near the middle of the cover 302. As such the cover 302 may fold in half or over on itself in order to move the cover 302 from the closed position to the open position.

In some implementations, the cover 302 may be a rigid or semi-rigid member or material, and the central hinge may be a mechanical hinge. In other implementations, the cover 302 may be constructed of a soft or flexible material, such as a padded material or felt-like material, and the central hinge may be a folding portion of the flexible material. In other words, a user may be able to fold the soft cover over on itself in order to reveal the eye lens 304 and utilize the HMD 301.

In some implementations, the HMD 301 may further include an inner attachment portion 330 disposed on or near an inner side of the eye lens 304, and an outer attachment portion 332 disposed on or near a face gasket 312 of the HMD 301. The lens cap 300 may include a complementary attachment portion 328 to attach to both the inner attachment portion 330 and the outer attachment portion 332, depending on the position of the cover 302. The complementary attachment portion 328 may be disposed on a distal end of the cover 302 and may attach to the inner attachment portion 330 when disposed in the closed position in order to hold the cover 302 in the open position. Similarly, the complementary attachment portion 328 may attach to the outer attachment portion 332 when disposed in the open position in order to hold the cover 302 in the open position. The inner and outer attachment portions 330 and 332, as well as the complementary attachment portion 328, may utilize any suitable fastening component, e.g., magnets, hook and loop fasteners, etc. in order to stay attached to one another.

What is claimed is:

1. A lens cap, comprising:
a cover sized to overlay an eye lens of a head-mounted display (HMD); and
a dual hinge to move the cover between an open position and a closed position, the dual hinge having a first hinge attached to the cover and a second hinge to attach to a chassis of the HMD.

2. The lens cap of claim 1, wherein the dual hinge is to space the cover away from the eye lens and adjacent to a face gasket attached to the chassis when the cover is disposed in the open position.

3. The lens cap of claim 2, wherein the dual hinge is to rotate and translate the cover away from the eye lens when the cover is moved to the open position.

4. The lens cap of claim 1, wherein the second hinge has an upper hinge portion and a lower hinge portion, the upper hinge portion and the lower hinge portion engaged with the first hinge by an upper hinge bracket and a lower hinge bracket, respectively.

5. The lens cap of claim 1, wherein the second hinge is attached to a lens trim peripherally surrounding the eye lens, wherein the cover is to move relative to the lens trim when moved between the open position and closed position.

6. A head-mounted display (HMD), comprising:
a chassis;
a display disposed within the chassis;
an eye lens disposed in front of the display; and
a lens cap, comprising:
a cover to removably cover the eye lens; and
a dual hinge having a first hinge and a second hinge, the dual hinge to pivotably attach the lens cap to the chassis adjacent to the eye lens.

7. The HMD of claim 6, wherein the cover is movable between a closed position, disposed over the eye lens, and an open position, disposed away from the eye lens.

8. The HMD of claim 7, wherein the dual hinge is to rotate and translate the cover away from the eye lens and adjacent to a face gasket attached to the chassis so as to not interfere with a user when the cover is disposed in the open position.

9. The HMD of claim 6, wherein the eye lens is a first eye lens and the lens cap is a first lens cap, and wherein the HMD further comprises a second eye lens disposed in front of the display and a second lens cap comprising a cover to removably cover the second eye lens and a dual hinge having a first hinge and a second hinge.

10. A virtual-reality (VR) system, comprising:
a computing device to provide visual immersive content; and
a head-mounted display (HMD) operably connected to the computing device and comprising:
a chassis;
a display disposed within the chassis;
a face gasket extending around an outer edge of the chassis;
an eye lens disposed in front of the display; and
a lens cap attached to the eye lens, comprising:
a cover sized to overlay the eye lens; and
a hinging portion to move the cover between a closed position and an open position.

11. The VR system of claim 10, wherein the cover of the lens cap is spaced away from the first eye lens and disposed adjacent to the face gasket when disposed in the open position.

12. The VR system of claim 11, wherein the hinging portion is a dual hinge disposed near an outer edge of the cover, the dual hinge having a first hinge and a second hinge to rotate and translate the cover between the closed position and the open position.

13. The VR system of claim 11, wherein the hinging portion is a central hinge disposed in the middle of the cover to fold the cover in half to move the cover from the closed position to the open position.

14. The VR system of claim 13, wherein the cover is a flexible material and the central hinge is a folding portion of the flexible material.

15. The VR system of claim 14, wherein the HMD further comprises an inner attachment portion disposed on an inner side of the eye lens, and an outer attachment portion disposed on the face gasket, and wherein the lens cap further comprises a complementary attachment portion to attach to the inner attachment portion when the cover is in the closed position and to attach to the outer attachment portion when the cover is in the open position.
